(19) United States
(12) Patent Application Publication
(10) Pub. No.: US 2023/0230126 A1
(43) Pub. Date: Jul. 20, 2023

(54) METHODS AND SYSTEMS FOR TRAINING AND USING PREDICTIVE RISK MODELS IN SOFTWARE APPLICATIONS

(71) Applicant: INTUIT INC., Mountain View, CA (US)

(72) Inventors: Nazanin Zaker HABIBABADI, Sunnyvale, CA (US); Wei WANG, Santa Clara, CA (US); Xue HAN, Sunnyvale, CA (US); Zhicheng XUE, Union City, CA (US); Yue YU, Mountain View, CA (US)

(21) Appl. No.: 17/579,341

(22) Filed: Jan. 19, 2022

(51) Int. Cl. G06Q 30/02; G06Q 40/02; G06N 20/20

(52) U.S. Cl. CPC G06Q 30/0255; G06Q 40/025; G06N 20/20

(57) ABSTRACT

Certain aspects of the present disclosure provide techniques for training predictive risk models based on user transaction history. An example method generally includes extracting, from a transaction history data set for a plurality of users of a software application, a plurality of features for each user of the plurality of users having records in the transaction history data set. A training data set is generated based on the extracted plurality of features for each user of the plurality of users. A plurality of predictive risk models is trained to generate a risk propensity score indicating a likelihood that a specified event will occur based on the training data set. Generally, monotonicity of one or more constraints is implemented in the model.

### INTRODUCTION

Aspects of the present disclosure relate to predictive models, and more specifically training and using predictive risk models trained with transaction data from other users of the software application.

### BACKGROUND

Software applications are generally deployed for use by many users for the performance of a specific function. These applications may be deployed as web applications accessible over the Internet or a private network or as desktop applications including static components executed from a local device and dynamic components executed from content retrieved from a network location. These applications can include financial applications, such as tax preparation applications, accounting applications, personal or business financial management applications, or the like; social media applications; other electronic communications applications; and so on.

Some applications may include components that allow messages for goods or services to be presented to a user while the user is interacting with the application (e.g., in an interstitial page between different components of a web application, in a dedicated advertising panel in an application, in electronic communications sent to the user after a user begins interacting with the application, etc.). These messages may be textual messages that require a minimal amount of overhead to add to network communications between a client device and an application. However, some messages may include audio and/or visual components which may impose more overhead for transmitting the message to a client device.

In some cases, the messages presented to a user may be randomly selected by a message placement engine. These messages, however, may be for goods or services that are not relevant to the user. Even where a message may be relevant to a user, the user may not actually qualify for the advertised offer. In either case, i.e., delivering messages to a user that are not relevant to the user or messages for offers that a user is not qualified for, resources (e.g., network bandwidth, user data caps, etc.) are wasted, which that could be used for other productive purposes.

Further, in some cases, users may not have a risk score from an external provider that can be used to aid in determining offers for which a user may be qualified. For these users, messages may be randomly generated, which, as discussed above, may result in wasted computing resources when irrelevant offers or offers for which the user is not qualified are presented. Even where a user does have a risk score from an external provider, these risk scores may not provide sufficient information to determine whether a user is qualified for an offer.

Thus, techniques are needed for presenting targeted offers that are relevant to a user of the software application and for presenting targeted offers for which the user of the software application is likely qualified.

### BRIEF SUMMARY

Certain embodiments provide a computer-implemented method for training predictive risk models based on user transaction history. An example method generally includes extracting, from a transaction history data set for a plurality of users of a software application, a plurality of features for each user of the plurality of users having records in the transaction history data set. A training data set is generated based on the extracted plurality of features for each user of the plurality of users. A plurality of predictive risk models are trained to generate a risk propensity score indicating a likelihood that a specified event will occur based on the training data set. Generally, the predictive model enforces monotonicity of one or more constraints on the model.

Still further embodiments provide a computer-implemented method for generating and presenting targeted offers to a user (e.g., of a software application). An example method generally includes generating a risk score for a user based on a predictive risk model trained to generate a risk propensity score indicating a likelihood that a specified event will occur and an input data set including a plurality of features from a transaction history associated with the user. Based on the generated risk score, a risk classification is determined for the user. A targeted offer is generated for the user based on the risk classification for the user, and the targeted offer is presented to the user.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment in which targeted messages are delivered to users of a software application based on a predictive risk model trained using a transaction history data set.

FIGS. 2A and 2B illustrate example segmentations of users generated using a predictive risk model trained using a transaction history data set.

FIG. 3 illustrates example operations for training a plurality of predictive risk models based on a transaction history data set.

FIG. 4 illustrates example operations for presenting targeted offers to users of a software application based on predictive risk models trained based on a transaction history data set.

FIG. 5 illustrates an example system on which embodiments of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

In various software applications, various offers may be presented to users of the software application. Because these offers may be intrusive and impose resource costs (e.g., bandwidth, processing, etc. for delivering offers to users of the software application), targeting techniques are generally used in an attempt to deliver relevant offers to a user. Generally, a relevant offer may be an offer that the user is likely to be interested in receiving and is qualified to receive. By delivering these “relevant” offers to a user, network bandwidth and other compute resources may be more efficiently utilized, as targeting techniques may generally reduce the likelihood that irrelevant offers are presented to a user of the software application.

In some cases, these offers may be offers that are based on a risk score for a user. For example, an offer for a loan product may be based on a credit score from an external party that indicates a user's likelihood of failing to satisfy an obligation, such as a FICO® score, a VantageScore®, or the like. However, some users may not have these external risk scores (also referred to herein as “external risk propensity scores”), and thus, it may not be possible for offers to be presented to these users. Further, even when users have external risk scores, these scores may not provide sufficient information to determine whether a user is qualified for an offer and thus whether the offer should be presented to the user.

Because users may not have external risk scores and because the risk scores generated for other users may not provide sufficient information for generating and presenting an offer to a user, some users may not be presented with offers that they would otherwise be qualified to receive, and other users may be presented with offers that they are in fact not qualified to receive. In computing systems that present such offers to users of applications executing within the computing system, this may therefore represent a misallocation of resources within the computing system. Resources (e.g., bandwidth, processing capabilities, memory, etc.) may be expended by presenting offers to users who are not qualified to receive such offers. Further, these wasted resources may be better used by presenting offers to other users that are qualified to receive such offers and, in some cases, are likely to interact with such offers.

Aspects of the present disclosure provide techniques for generating and presenting targeted offers to users (e.g., of a software application) based on predictive models that can operate alone or in conjunction with external risk propensity scores in order to determine a risk classification for a user. As discussed in further detail herein, the predictive models can generate risk scores based on transaction data associated with a user of a software application, and the risk scores can be combined with external risk scores to determine a risk cluster associated with the user. Based on the risk cluster associated with the user, offers can be dynamically generated and presented to users, and these offers may have parameters that are appropriate for the risk cluster in which the user lies and thus be relevant to the user. Because these offers may be generated based on risk clustering, offers may be tailored and presented to users who are likely to qualify for a given offer, and irrelevant offers may not be generated and presented to users. Thus, aspects of the present disclosure improve the user experience of a software application by presenting targeted offers only to users who are qualified for the targeted offer. Further, by presenting targeted offers only to users who are qualified for the targeted offer, embodiments of the present disclosure may reduce the amount of bandwidth used in delivering application content to users of the software application.

### Example Training Predictive Risk Models and Generating Offers Using the Predictive Risk Models

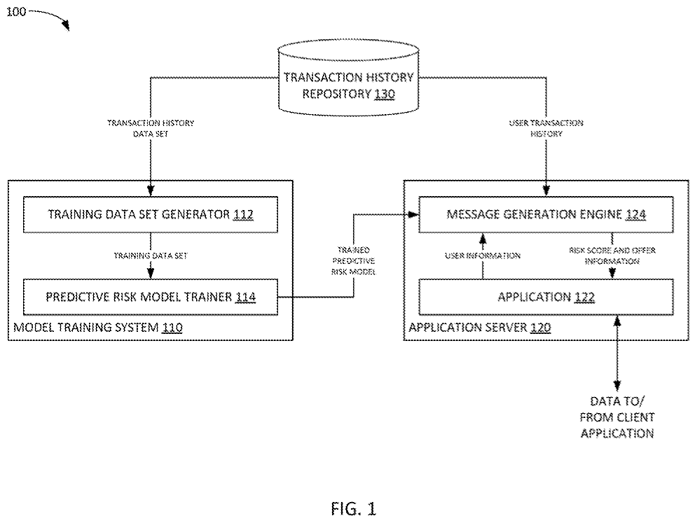

FIG. 1 illustrates an example computing environment 100 in which predictive models are trained and used to generate offers to be presented to users of a software application. As illustrated, computing environment 100 includes a model training system 110, and application server 120, and transaction history repository 130.

Model training system 110 generates training data sets from transaction histories associated with various users of a software application and trains a predictive risk model using the generated training data sets. Model training system 110 may be any of a variety of computing devices that can generate training data sets and train predictive models based on these training data sets, such as a server computer, a cluster of computers, cloud computing instances, or the like. As illustrated, model training system 110 includes a training data set generator 112 and a predictive risk model trainer 114.

Training data set generator 112 may be configured to retrieve transaction history data for a plurality of users of a software application from transaction history repository 130 and generate one or more training data sets from the transaction history data. In some aspects, to generate the training data sets, training data set generator 112 can initially bifurcate the transaction history data into a first set of transaction history data associated with users who have an external risk propensity score and a second set of transaction history data associated with users who do not have an external risk propensity score. By bifurcating the transaction history data into the first set (for users having an external risk propensity score) and the second set (for users lacking an external risk propensity score), training data set generator 112 can establish unique training data sets for use in training a plurality of predictive risk models (e.g., a first predictive risk model for users having an external risk propensity score and a second predictive risk model for users lacking an external risk propensity score).

Each set of transaction history data may include transaction history information for a plurality of users. For example, the first set of transaction history data may include subsets of transaction history information associated with each user who has an external risk propensity score, and the second set of transaction history data may include subsets of transaction history information associated with each user who does not have an external risk propensity score. For each subset (associated with a specific user), training data set generator 112 can extract a plurality of features that may be indicative of that user's risk of failing to complete a transaction (e.g., a risk of failing to satisfy an obligation on the conditions set forth in that obligation, such as a failure to pay a loan or credit card on time, a default on one or more terms of a financial instrument, etc.). The features may be classified, at least implicitly, as positive features indicative of a likelihood that the user will complete a transaction and negative features indicative of a likelihood that the user will not complete the transaction. Positive features may include, for example, a lack of overdrafts in a transaction history associated with a current account (e.g., a checking account, savings account, or other demand deposit account from which funds may be withdrawn on demand), a regular payment history, positive trends with respect to an available balance within an account, or the like. Negative features, conversely, may include a number of overdrafts in the transaction history exceeding a threshold number, inconsistent payment history on various obligations, negative trends with respect to the available balance within the account, or the like.

In some aspects, the features extracted from the transaction history data set may be a subset of a universe of features that can be extracted from the transaction history data set or otherwise used to train a predictive risk model. The subset of features may be selected based on a predictive power of each feature in the universe of features calculated from a historical data set of event outcomes. For example, assume that the transaction history data set is associated with users who have received a loan. A positive outcome would generally correspond to the payment of the loan in full on or before a maturity date, while a negative outcome would generally correspond to payment of only a portion of the loan by the maturity date or other default event indicating that the loan was not satisfied in full. To determine what features are likely to be relevant to a predictive risk model and what features are unlikely to be relevant to the predictive risk model, a weight of evidence metric and an information value metric may be calculated for each feature in the universe of features.

Generally, the weight of evidence metric indicates the predictive power of a metric in relation to a positive or negative outcome for some event, such as a loan issued to a user. To calculate the weight of evidence metric for a feature, values of the feature can be divided into a plurality of bins. Within each bin, a number of events (e.g., failures to satisfy an obligation) and a number of non-events (e.g., satisfaction of an obligation) can be calculated, and the weight of evidence metric for a specific bin may be calculated as the natural log of the rate at which non-events occurred within the bin divided by the rate at which events occurred within the bin (e.g., according to the equation

$$W o E = ln \frac{PctOfNonEvents}{PctOfEvents} ) ,$$

where PctOfNonEvents is the percentage of events in the bin of transaction data that do not correspond to negative event outcomes, and PctOfEvents is the percentage of events in the bin of transaction data that correspond to negative event outcomes. The information value metric may be calculated for the metric based on a summation of the difference between the rate at which non-events occurred and the rate at which events occurred within each bin, multiplied by the weight of evidence metric (e.g., according to the equation IV=Σᵢ₌₀ⁿ⁻¹(PctOfNonEventsᵢ−PctOfEventsᵢ)×WoE, where n represents the number of bins into which the metric was divided).

Features included in the subset of features included in the training data set(s) may generally be the features having a weight of evidence metric exceeding a threshold value and an information value metric indicating that a metric has at least some predictive power. In some aspects, the features having information value metrics exceeding some threshold value may be selected further based on a normalized gain metric and a validation sample, which may result in the selection of a minimal set of features to be used in training the predictive risk models. A gain metric associated with a feature may correspond to the relative contribution of a feature to classifications made by a predictive risk model (e.g., a contribution of a feature to a classification of a user into one of a plurality of risk segments using the predictive risk model). A normalized gain metric for a feature may be calculated by dividing the gain metric for the feature by the sum of the gains calculated over each of the features included in a training data set and used to initially train the predictive risk model. A subset of the features from the universe of features may be selected for use in generating the training data set by maximizing various model performance statistics, such as a Kolmogorov-Smirnov test measuring the distance between two probability distributions from the transaction history data set.

Predictive risk model trainer 114 generally trains one or more predictive risk models based on the training data sets generated by training data set generator 112. In some aspects, where training data set generator 112 generates a first data set for users with external risk propensity scores and a second data set for users without external risk propensity scores, predictive model trainer 114 may train a first predictive risk model for users with external risk propensity scores and a second predictive risk model for users without external risk propensity scores. Generally, the predictive risk models may be trained to generate a risk propensity score indicating a likelihood that a specified event will occur based on the training data set. Such a specified event may include, for example, a failure to complete a transaction (e.g., on the terms set forth for the transaction when the transaction was originated, such as when a loan is originated to a user). The risk propensity score may be, for example, a score between 0 and 1, where a 1 value indicates that a user has a high likelihood of failing to complete a transaction and a 0 value indicates that a user has a low likelihood of failing to complete a transaction (or vice versa).

In some aspects, the predictive risk models may be regularizing gradient boosting models, such as an XGBoost model. The regularizing gradient boosting model may include local explainability values associated with each feature of the plurality of features. These local explainability value may indicate, for example, the effect of a given feature value on the output of the model and may be used within a software application to explain, to a user of the software application, why the user received a particular offer, how the user's risk propensity score was generated and what factors contributed to the user's risk propensity score, and the like. These local explainability values allow for decisions made using the predictive risk models to be explained, which may give users of a software application insight into how and why an application reached a particular outcome, unlike black-box models that do not allow for any explanation of how and why a particular outcome was generated for a user.

The predictive risk models may generally enforce the monotonicity of one or more constraints on the model so that the models reflect a priori known relationships between a feature in the models and a target state. Generally, enforcing the monotonicity of these constraints may reduce oscillatory behavior in the model. For example, higher risk propensity scores may be associated with higher numbers of positive events in the transaction history associated with the user, and the models may likewise enforce the monotonicity of this constraint.

In some aspects, predictive risk model trainer 114 can generate a user segmentation model based on the one or more predictive risk models. The user segmentation model may be generated using a mixed integer optimization algorithm in which each constraint within the model is modeled as a set of integers. To generate the user segmentation model, a plurality of segments may be generated based on the variation of a negative event rate across different segments within the model. The negative event rate may be maximized such that users with high likelihoods of experiencing negative events are separated from users with low likelihoods of experiencing negative events, and the segments may be ranked accordingly. For example, to generate the segment, mixed integer optimization can maximize a slope of specified event rates across each of the generated segments in the user segmentation model, assuming that various constraints within the model are met.

After training the plurality of predictive risk models (and, in some aspects, the user segmentation model), the plurality of predictive risk models may be deployed to an application server 120 for use in generating offers to users of an application 122 executing on the application server 120. For example, as illustrated, the plurality of predictive risk models may be deployed to a message generation engine 124 executing on or otherwise associated with application server 120.

Application server 120 generally hosts an application which may be accessed by users of the application and may provide a set of functions to users of the application. As illustrated, application server 120 includes an application 122 and message generation engine 124.

In some aspects, during execution of the application 122, application 122 may determine that a user should be presented an offer. Such a determination may be, for example, based on user interaction with the application 122 indicating that a user is transitioning from one workflow in the application 122 to another workflow in the application 122, based on an amount of time spent within the application, or the like. When application 122 determines that a user should be presented with an offer, application 122 may provide user information to message generation engine 124 and instruct message generation engine 124 to generate an offer for the user based on one or more predictive risk scores generated for the user. Application 122 may receive, from message generation engine 124, a predictive risk score for the user and information about an offer to be presented to the user and may output at least the information about the offer to the user of application 122. In some aspects, application 122 may provide (e.g., upon request by the user), information about the predictive risk score to the user to explain why the user received a particular offer. The offer, for example, may be an offer for a loan product with a given interest rate, term, and amount. In some aspects, the offer may be for multiple loan products, with each loan product having a different set of interest rate, term, and amount parameters.

Message generation engine 124 generally receives the user information from application 122, calculates a risk score and risk classification for the user, and generates a targeted offer for the user. To calculate a risk score and risk classification for the user, message generation engine 124 can determine whether an external risk propensity score exists for the user. If an external risk propensity score exists for the user, message generation engine 124 can generate a risk score for the user using the model trained for users with external risk propensity scores; otherwise, message generation engine 124 can generate a risk score for the user using the model trained for users without external risk propensity scores.

Based on the risk score generated by message generation engine 124, a classification of the user into one of a plurality of risk classifications may be performed. Generally, the classification of the user may be based on a user segmentation model that divides users into one of a plurality of risk classification segments. For users having external risk classification scores, the user segmentation model may be based on the user's external risk propensity score and the risk score generated by message generation engine 124. For users lacking external risk classification scores, the user segmentation model may be solely based on the risk score generated by message generation engine 124.

Based on the classification of the user into one of a plurality of risk classifications, message generation engine 124 can generate an offer for the user. Generally, message generation engine 124 may be configured to generate offers with higher interest rates or more restrictions for users having higher risk classifications and may be configured to generate offers with lower interest rates or fewer restrictions (e.g., whether the loan is secured or unsecured, limitations on what the loan can be used for, etc.) for users having lower risk classifications. In some aspects, where message generation engine 124 is used to generate offers of loan products for users of application 122, message generation engine 124 can generate one or more offers, each with a unique combination of rate, term, and amount, according to the risk classification for the user. In some aspects, various rules may be used to determine the combination of rate, term, and amount offered to a user. For example, different risk classifications may be associated with different minimum rates, different maximum amounts, and/or different maximum terms, to account for the amount of risk associated with users in a given risk classification. Users with the highest risk classifications from a user segmentation model may have the highest minimum rate, shortest term, and/or smallest amount parameters, and users in lower risk classifications may have lower minimum rates, longer terms, and/or larger amount parameters.

In some aspects, because the predictive risk models may be regularizing gradient boosting models with local explainability values, application 122 can provide information (e.g., upon request) to a user to explain how the predictive risk models generated the user's risk propensity score, the classification of the user into one of the plurality of segments in the user segmentation model, and the parameters of the message generated and displayed to the user in application 122. For example, application 122 can display, to the user, information explaining the features from the user's transaction history that contributed to the user's risk propensity score. Further, application 122 can display information about the risk segment in which the user was classified and explain, based on the risk segment, why the user received the offer with the parameters of that offer.

### Example User Segmentation Generated Using Predictive Risk Models

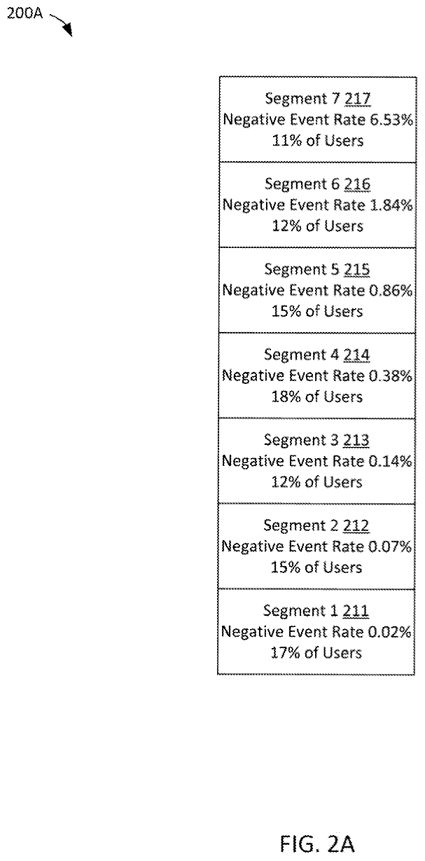

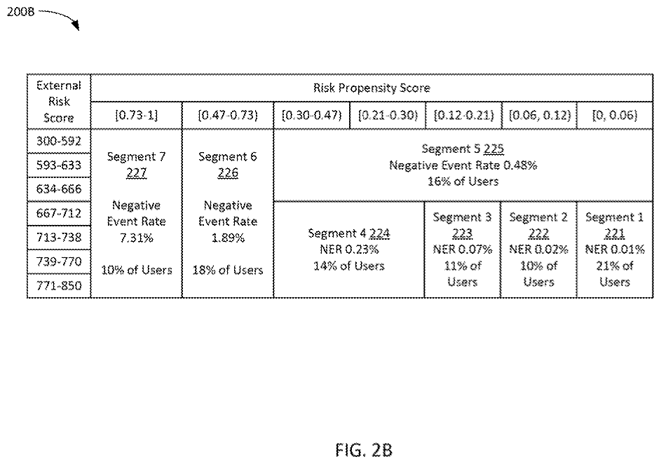

FIGS. 2A and 2B illustrate example user segmentations generated (e.g., by predictive risk model trainer 114 illustrated in FIG. 1) for users based on risk scores generated by a predictive model based on transaction history data for the user. FIG. 2A illustrates an example user segmentation model 200A generated and deployed by predictive risk model trainer 114 and used to generate targeted messages by message generation engine 124 illustrated in FIG. 1 for users who lack an external risk propensity score, while FIG. 2B illustrates an example user segmentation model 200B generated and deployed by predictive risk model trainer 114 and used to generate targeted messages by message generation engine 124 illustrated in FIG. 1 for users who have an external risk propensity score.

As illustrated in FIG. 2A, a user segmentation model 200A generated and deployed by predictive risk model trainer 114 and used to generate targeted messages by message generation engine 124 may be divided into segments 211 through 217, with each segment representing a particular range of risk propensity scores generated by a predictive model. Segment 211 may correspond to a set of users with the highest risk, and segments 212 through 217 may correspond to sets of users with decreasing amounts of risk, as illustrated by the negative event rate associated with users in each segment 211 through 217. For example, segment 1 211 may be associated with users having risk propensity scores between 0 and 0.06; segment 2 212 may be associated with users having risk propensity scores between 0.06 and 0.12, segment 3 213 may be associated with users having risk propensity scores between 0.12 and 0.21, segment 4 214 may be associated with users having risk propensity scores between 0.21 and 0.30, segment 5 215 may be associated with users having risk propensity scores between 0.30 and 0.47, segment 6 may be associated with risk propensity scores between 0.47 and 0.73, and segment 7 may be associated with users having risk propensity scores between 0.73 and 1, where lower risk propensity scores indicate a lower risk that a negative event will occur (e.g., that a user will fail to complete a transaction). Of course, if should be recognized that the ranges described herein are only examples of possible ranges, and other ranges of values, numbers of segments, etc. are possible.

FIG. 2B illustrates a user segmentation model 200B generated and deployed by predictive risk model trainer 114 and used to generate targeted messages by message generation engine 124 in which users are segmented into risk segments based on an external risk score and a risk propensity score generated by a predictive model. In this example, the external risk scores is divided into a plurality of segments: from 300 through 592, from 593 through 633, from 634 through 666, from 667 through 712, from 713 through 738, from 739 through 770, and from 771 through 850. Like in the user segmentation model 200A illustrated in FIG. 2A, the generated risk propensity scores may be segmented into a plurality of segments: from 0.73 through 1, from 0.47 through 0.73, from 0.30 through 0.47, from 0.21 through 0.30, from 0.06 through 0.12, and from 0 through 0.06.

The segments 221 through 227 in user segmentation model 200B may be generated based on one or both the external risk scores and the generated risk propensity scores. For example, for users with a generated risk propensity score (from a predictive model trained using user transaction history data) between 0.73 and 1, it may be determined that these users have a high likelihood that a negative event will occur; thus, regardless of the external risk score associated with these users, these users will be assigned to segment 1 221. Similarly, for users with generated risk propensity scores between 0.47 and 0.73, these users will be assigned to segment 2 222 regardless of the external risk score associated with these users. In still another example, for users with external risk scores in any of the 300 through 592, 593 through 633, or 634 through 666 segments, these users may be assigned to segment 3 223 regardless of the generated risk propensity score associated with these users.

Segments 224 through 227 may be smaller segments that are based on both the external risk score and the generated risk propensity score. Users with external risk scores between 667 and 850 and risk propensity scores between 0.21 and 0.47 may be assigned to segment 4 224. Meanwhile, users with external risk scores between 667 and 850 and risk propensity scores between 0.12 and 0.21 may be assigned to segment 5 225; users with external risk scores between 667 and 850 and risk propensity scores between 0.06 and 0.12 may be assigned to segment 6 226; and users with external risk scores between 667 and 850 and risk propensity scores between 0 and 0.06 may be assigned to segment 7 227.

Generally, the user segmentation models 200A and 200B may be closely associated with the predictive risk models trained based on user transaction data, as discussed above. The user segmentation models 200A and 200B may include a plurality of segments based on ranges of scores generated by the predictive risk models, and these segments may be generated based on an analysis of cumulative distribution functions associated with positive and negative events in the training data set.

### Example Methods for Training Predictive Risk Models Based on Transaction History and Generating Targeted Offers Using Trained Predictive Risk Models

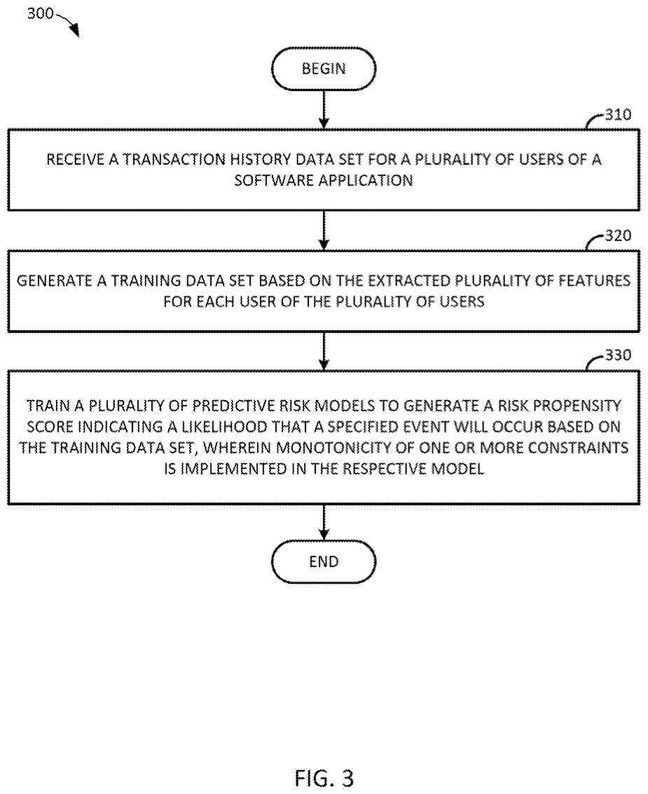

FIG. 3 illustrates example operations 300 that may be performed to train a plurality of predictive risk models based on a transaction history data set, in accordance with aspects of the present disclosure. Operations 300 may be performed, for example, by model training system 110 illustrated in FIG. 1 or other computing devices on which predictive models can be trained.

As illustrated, operations 300 begin at block 310, where a transaction history data set is received. The transaction history data set may be received for a plurality of users of a software application. In some aspects, the transaction history data set may include transaction information associated with current accounts owned by each of the plurality of users, and each user of the plurality of users may be associated with a loan or other product that is to be offered using the plurality of predictive models.

At block 320, a training data set is generated based on the extracted plurality of features for each user of the plurality of users. The plurality of features extracted for each user may be a subset of features from a universe of features, and the subset of features may be selected based on a predictive power of each respective feature in the universe of features.

In some aspects, the predictive power of a given feature in the universe of features may be calculated from a historical data set of event outcomes. The predictive power may be calculated based on an information value metric for the given feature. To calculate the information value metric, values for a feature may be divided into a plurality of bins, and a weight of evidence metric for a particular bin may be calculated based on the number of non-events associated with the feature and a number of events associated with the feature. The information value metric may be based on a summation, over the plurality of bins, of the difference between the number of non-events and the number of events, weighted by the weight of evidence metric for the feature.

In some aspects, the plurality of features may be further or alternatively selected based on a normalized gain metric associated with each feature. The normalized gain metric may be based on gain values associated with each feature in a universe of features (e.g., in an XGBoost model or other model for which gain metrics can be extracted on a per-feature basis) and an overall gain value over the universe of features. The plurality of features may be selected as features having information value metrics exceeding a threshold value.

At block 330, a plurality of predictive risk models is trained to generate a risk propensity score. Generally, the risk propensity score may indicate a likelihood that a specified event will occur based on the training data set. Each respective predictive model of the plurality of predictive risk models may enforce the monotonicity of constraints on the respective model. For example, where the specified event is a negative event, the number of negative events may be assumed to decrease monotonically as the amount of risk decreases, as users having a lower risk of experiencing a negative event (e.g., a loan default) may have smaller numbers of negative events in their transaction history, while users having a higher risk of experiencing a negative event may have a larger number of negative events in their transaction history. Therefore, the negative monotonicity of a negative event constraint may be enforced by the predictive model.

In some aspects, the plurality of predictive risk models may include a first model for users of the software application having an external risk score and a second model for users of the software application lacking the external risk score. As discussed, to allow for both of these models to be trained, the training data set may include a first training data set of features extracted from transaction history data for users having an external risk score and a second data set of features extracted from transaction history data for users lacking an external risk score.

In some aspects, a user segmentation model (e.g., such as user segmentation models 200A or 200B illustrated in FIGS. 2A and 2B, respectively) may be generated based on the predictive risk models. The user segmentation model may include a plurality of segments. These segments may be selected based on the variation of negative event rates in each segment so that the variation in each segment is maximized. The variation of negative event rates may be calculated, for example, based on a cumulative distribution function for positive events associated with users in a segment and a cumulative distribution function for negative events associated with users in a segment, and the risk scores bounding each segment may be selected to maximize a difference calculated between the positive event cumulative distribution function and the negative event cumulative distribution function. The user segmentation model may, in some aspects, be generated based on a mixed integer optimization algorithm. In generating the user segmentation model, a model training system (e.g., model training system 110 illustrated in FIG. 1) generates a plurality of segments based on the variation of a negative event rate across different segments within the model. The negative event rate may be maximized such that users with high likelihoods of experiencing negative events are separated from users with low likelihoods of experiencing negative events, and the segments may be ranked accordingly. For example, these segments may be ranked with the riskiest segment having a highest rank and less risky segments having correspondingly lower ranks.

In some aspects, the trained plurality of predictive risk models may be deployed for use. The trained plurality of predictive models may be deployed, for example, to an message generation engine, such as message generation engine 124 illustrated in FIG. 1, executing on an application server associated with an application in which targeted offers generated by the message generation engine are to be presented.

In some aspects, the risk propensity score is associated with a risk, or likelihood, that an event will fail to occur. For example, the risk may correspond to a risk that a transaction will fail to be completed according to the parameters established for such a transaction. The transaction may be, in some aspects, the origination of a loan or other repayable obligation, and the risk may correspond to non-payment, partial payment, or default on the loan or other repayable obligation.

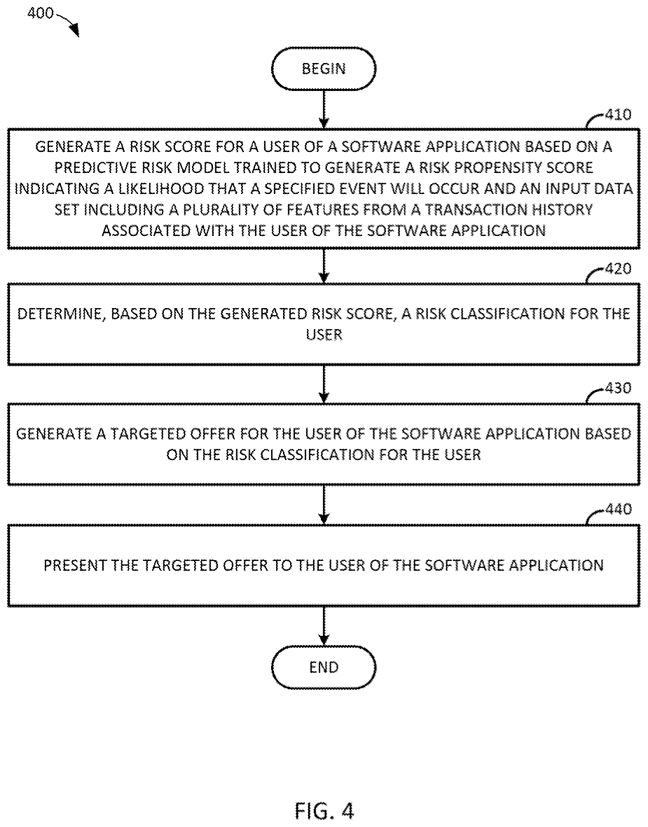

FIG. 4 illustrates example operations that may be performed to generate and present targeted offers to users based on predictive risk models trained using transaction history data. Operations 400 may be performed, for example, by a message generation engine or other engine on which one or more predictive models is deployed, such as message generation engine 124 illustrated in FIG. 1.

As illustrated, operations 400 begin at block 410, where a risk propensity score is generated for a user based on a predictive risk model and an input data set including a plurality of features from a transaction history associated with the user. The predictive risk model is generally trained to generate a risk propensity score indicating a likelihood that a specified event will occur, as discussed above with respect to FIG. 3. As discussed, the plurality of features may be extracted from a transaction history, such as an event history in a current account associated with the user.

In some aspects, the risk propensity score may be generated based on a determination of whether an external risk score exists for the user. If an external risk score exists for the user, the model for users with external risk scores is used to generate the risk propensity score. Otherwise, since an external risk score does not exist for the user, the model for users without external risk scores is used to generate the risk propensity score.

Generally, the risk propensity score may comprise a credit score indicating a likelihood that the user will fail to satisfy an obligation. Generally, lower credit scores may indicate a higher likelihood that the user will fail to satisfy an obligation than higher credit scores.

At block 420, a risk classification is determined for the user based on the generated risk score. The risk classification may be determined based on a user segmentation model dividing users into one of a plurality of risk segments. Each segment may be associated with a different level of risk. In some aspects, segments associated with lower risk propensity scores may be associated with higher levels of risk, while segments associated with higher risk propensity scores may be associated with lower levels of risk. The user segmentation model may be selected based on whether an external risk score exists for the user. If an external risk score exists for the user, the user segmentation model may segment users into a plurality of segments based on one or both of the external risk score and the generated risk propensity score. Otherwise, the user segmentation model may segment users into a plurality of segments based on the generated risk propensity score alone.

At block 430, a targeted offer is generated for the user based on the risk classification for the user. As discussed, targeted offers may be generated with parameters that change depending on whether the user is deemed to be in a low-risk segment or a high-risk segment. For a loan product, the parameters may include an interest rate, term, and amount, and each segment may be associated with a minimum interest rate, maximum term, and maximum amount. Users in higher risk segments may be offered loans with higher interest rates, shorter terms, and/or smaller amounts than users in lower risk segments.

At block 440, the targeted offer is presented. For example, the targeted offer may be displayed by an application with which the user is interacting. In another example, the targeted offer may be presented by generating and transmitting one or more messages to the user, e.g., within the application with which the user is interacting, via electronic messaging techniques (e.g., electronic mail, text messages, push notifications, etc.).

### Example Systems for Training Predictive Risk Models and Generating Offers Using the Predictive Risk Models

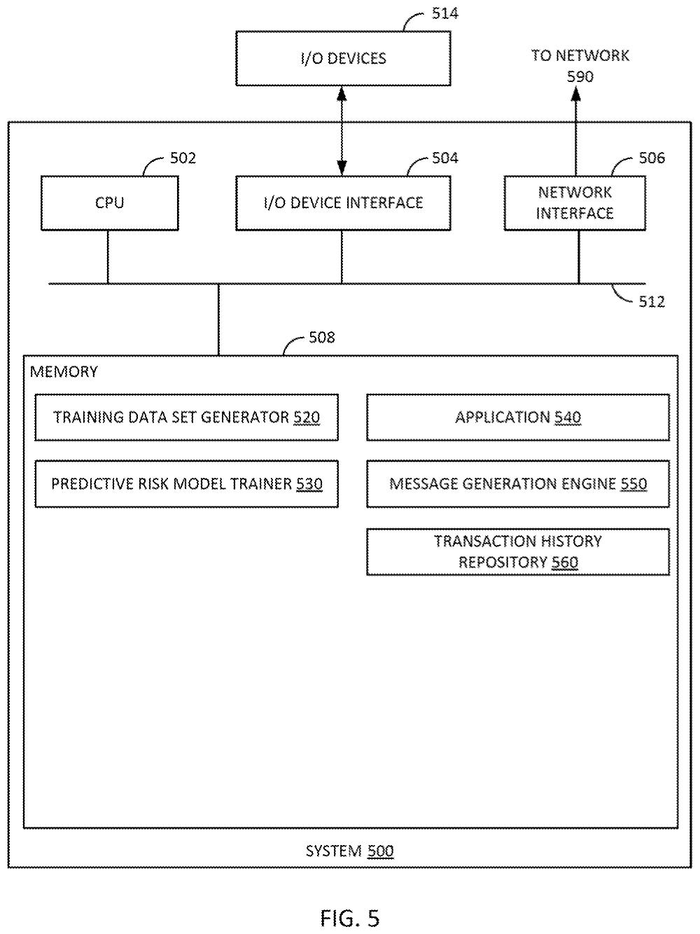

FIG. 5 illustrates an example system 500 in which predictive risk models are trained and used to generate offers in a software application. System 500 may correspond to one or both of model training system 110 and application server 120 illustrated in FIG. 1.

As shown, system 500 includes a central processing unit (CPU) 502, one or more I/O device interfaces 504 that may allow for the connection of various I/O devices 514 (e.g., keyboards, displays, mouse devices, pen input, etc.) to the system 500, network interface 506 through which system 500 is connected to network 590 (which may be a local network, an intranet, the internet, or any other group of computing devices communicatively connected to each other), a memory 508, and an interconnect 512.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508.

CPU 502 is included to be representative of a single CPU, multiple CPUs, a single CPU having multiple processing cores, and the like.

Memory 508 is representative of a volatile memory, such as a random access memory, or a nonvolatile memory, such as nonvolatile random access memory, phase change random access memory, or the like. As shown, memory 508 includes a training data set generator 520, predictive risk model trainer 530, application 540, message generation engine 550, and transaction history repository 560.

Training data set generator 520 generally corresponds to training data set generator 112 illustrated in FIG. 1. Generally, training data set generator 520 uses a transaction history data set from transaction history repository 560 to generate one or more training data sets. The one or more training data sets may include a first training data set for users having external risk scores and a second training data set for users lacking external risk scores. Generally, the training data sets generated by training data set generator may include a plurality of features extracted from the transaction history data set for each user of a plurality of users, and these features may be selected based on the predictive power of such features.

Predictive risk model trainer 530 generally corresponds to predictive risk model trainer 114 illustrated in FIG. 1. Generally, predictive risk model trainer 530 uses the training data sets generated by training data set generator 520 to train one or more predictive risk models based on transaction history data for users of application 540 (and potentially other users who may not use application 540 but for which data exists in transaction history repository 560). The predictive risk models may include a first model for users having an external risk score and users lacking the external risk score, and the predictive risk models may be regularizing gradient boosting models with local explainability values associated with each feature of the plurality of features included in the training data sets.

Application 540 generally corresponds to application 122 illustrated in FIG. 1. Generally, application 540 receives requests from users of the application 540 for various features or functionality of the application and presents offers generated by message generation engine 550 to the users of the application.

Message generation engine 550 generally corresponds to message generation engine 124 illustrated in FIG. 1. Generally, message generation engine 550 uses the predictive models trained by predictive risk model trainer 530 and user transaction data retrieved from transaction history repository 560 to determine a risk classification for a user of application 540 and generate a targeted offer for the user. The targeted offer may be generated based on the segment of a user segmentation model that the user falls into based on the generated risk propensity score and (if applicable) an external risk score. Generally, message generation engine 550 can generate offers with higher rates, shorter terms, and/or smaller amounts for users of the application 540 in higher risk segments and can generate offers with lower rates, longer terms, and/or larger amounts for users in lower risk segments.

Note that FIG. 5 is just one example of a system, and other systems including fewer, additional, or alternative components are possible consistent with this disclosure.

### Example Clauses

Implementation examples are described in the following numbered clauses:

Clause 1: A method, comprising: extracting, from a transaction history data set for a plurality of users of a software application, a plurality of features for each user of the plurality of users having records in the transaction history data set; generating a training data set based on the extracted plurality of features for each user of the plurality of users; and training a plurality of predictive risk models to generate a risk propensity score indicating a likelihood that a specified event will occur based on the training data set, wherein each respective model of the plurality of predictive risk models enforce monotonicity of one or more constraints on the respective model.

Clause 2: The method of Clause 1, further comprising selecting the plurality of features as a subset of features in a universe of features based on a predictive power of each respective feature in the universe of features calculated from a historical data set of event outcomes.

Clause 3: The method of Clause 2, wherein: predictive power of a respective feature in the universe of features is calculated based on a weight of evidence metric and an information value metric associated with the respective feature; the weight of evidence metric is based on a ratio of positive events and negative events in each of a plurality of bins into which values of the respective feature or organized; and the information value metric is based on a summation of a difference between the ratio of positive events and negative events in each of the plurality of bins, weighted by the weight of evidence metric.

Clause 4: The method of any one of Clauses 1 through 3, further comprising selecting the plurality of features as a subset of features in a universe of features based on a normalized gain of each respective feature in the universe of features.

Clause 5: The method of any one of Clauses 1 through 4, wherein the predictive model comprises a regularizing gradient boosting model with local explainability values associated with each feature of the plurality of features.

Clause 6: The method of any one of Clauses 1 through 5, wherein the trained plurality of predictive risk models comprises a first model for users of the software application having an external risk score and a second model for users of the software application lacking the external risk score.

Clause 7: The method of any one of Clauses 1 through 6, further comprising generating, based on a difference between a likelihood of positive events and a likelihood of negative events, a user segmentation model including a plurality of segments, wherein: a variation of negative event rates across the plurality of segments is maintained, and the user segmentation model maximizes a slope of specified event rates across each segment of the plurality of segments.

Clause 8: The method of Clause 7, wherein the user segmentation model is generated based on a mixed integer optimization algorithm.

Clause 9: The method of any one of Clauses 1 through 8, further comprising deploying the trained plurality of predictive risk models.

Clause 10: The method of any one of Clauses 1 through 9, wherein the risk propensity score is associated with a likelihood that an event will fail to occur.

Clause 11: The method of Clause 10, wherein the event comprises satisfaction of an obligation.

Clause 12: A method, comprising: generating a risk score for a user based on a predictive risk model trained to generate a risk propensity score indicating a likelihood that a specified event will occur and an input data set including a plurality of features from a transaction history associated with the user; determining, based on the generated risk score, a risk classification for the user; generating a targeted offer for the user based on the risk classification for the user; and presenting the targeted offer to the user.

Clause 13: The method of claim 12, further comprising: determining whether an external risk score exists for the user; and selecting a model for the user with the external risk score or a model for the user without the external risk score as the predictive risk model based on the determination of whether the external risk score exists for the user.

Clause 14: The method of any one of Clauses 12 or 13, wherein determining the risk classification for the user comprises identifying, in a user segmentation model, a risk segment in which the user lies based at least on the generated risk score for the user.

Clause 15: The method of any one of Clauses 12 through 14, wherein the plurality of features comprise features selected from a universe of features based on a predictive power of each respective feature in a universe of features calculated from a historical data set of event outcomes.

Clause 16: The method of any one of Clauses 12 through 15, the risk score comprises a credit score indicating a likelihood that the user will fail to satisfy an obligation.

Clause 17: A system, comprising: a memory having executable instructions stored thereon; and a processor configured to execute the executable instructions to perform the methods of any one of Clauses 1 through 16.

Clause 18: A system, comprising: means for performing the methods of any one of Clauses 1 through 16.

Clause 19: A computer-readable medium having instructions stored thereon which, when executed by a processor, performs the methods of any one of Clauses 1 through 16.

### Additional Considerations

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method, comprising:
extracting, from a transaction history data set for a plurality of users of a software application, a plurality of features for each user of the plurality of users having records in the transaction history data set;
generating a training data set based on the extracted plurality of features for each user of the plurality of users; and
training a plurality of predictive risk models to generate a risk propensity score indicating a likelihood that a specified event will occur based on the training data set, wherein monotonicity of one or more constraints on the respective model is implemented.

2. The method of claim 1, further comprising selecting the plurality of features as a subset of features in a universe of features based on a predictive power of each respective feature in the universe of features calculated from a historical data set of event outcomes.

3. The method of claim 2, wherein:
the predictive power of a respective feature in the universe of features is calculated based on an information value metric associated with the respective feature; and
the information value metric is based on a summation of a difference between the ratio of positive events and negative events in each of a plurality of bins into which values of the respective feature are organized, weighted by a weight of evidence metric based ratio of positive events and negative events in each of the plurality of bins.

4. The method of claim 1, further comprising selecting the plurality of features as a subset of features in a universe of features by maximizing a separation between a cumulative distribution function for positive events and a cumulative distribution function for negative events for each segment of a plurality of segments in the user segmentation model.

5. The method of claim 1, wherein the plurality of predictive risk models comprises regularizing gradient boosting models with local explainability values associated with each feature of the plurality of features.

6. The method of claim 1, wherein the trained plurality of predictive risk models comprises a first model for users of the software application having an external risk score and a second model for users of the software application lacking the external risk score.

7. The method of claim 1, further comprising generating, based on a difference between a likelihood of positive events and a likelihood of negative events, a user segmentation model including a plurality of segments, wherein:
a variation of negative event rates across the plurality of segments is maintained, and
the user segmentation model maximizes a slope of specified event rates across each segment of the plurality of segments.

8. The method of claim 7, wherein the user segmentation model is generated based on a mixed integer optimization algorithm.

9. The method of claim 1, further comprising deploying the trained plurality of predictive risk models.

10. The method of claim 1, wherein the risk propensity score is associated with a likelihood that an event will fail to occur.

11. The method of claim 10, wherein the event comprises satisfaction of an obligation.

12. A method, comprising:
generating a risk score for a user based on a predictive risk model and an input data set including a plurality of features from a transaction history associated with the user, wherein:
the predictive risk model comprises a model trained to generate a risk propensity score indicating a likelihood that a specified event will occur based on a subset of features in a universe of features selected by maximizing a separation between a cumulative distribution function for positive events and a cumulative distribution function for negative events for each segment of a plurality of segments in a user segmentation model,
monotonicity of one or more constraints in the predictive risk model is implemented, and
the user segmentation model comprises a model that maximizes a slope of specified event rates across each segment of the plurality of segments,;
determining, based on the generated risk score, a risk classification for the user;
generating a targeted offer for the user based on the risk classification for the user; and
presenting the targeted offer to the user.

13. The method of claim 12, further comprising:
determining whether an external risk score exists for the user; and
selecting a model for the user with the external risk score or a model for the user without the external risk score as the predictive risk model based on the determination of whether the external risk score exists for the user.

14. The method of claim 12, wherein determining the risk classification for the user comprises identifying, in a user segmentation model, a risk segment in which the user lies based at least on the generated risk score for the user.

15. The method of claim 12, wherein the plurality of features comprise features selected from a universe of features based on a predictive power of each respective feature in a universe of features calculated from a historical data set of event outcomes.

16. The method of claim 12, the risk score comprises a credit score indicating a likelihood that the user will fail to satisfy an obligation.

17. A system, comprising:
a memory having executable instructions stored thereon; and
a processor configured to execute the executable instructions in order to:
extract, from a transaction history data set for a plurality of users of a software application, a plurality of features for each user of the plurality of users having records in the transaction history data set;
generate a training data set based on the extracted plurality of features for each user of the plurality of users; and
train a plurality of predictive risk models to generate a risk propensity score indicating a likelihood that a specified event will occur based on the training data set, wherein monotonicity of one or more constraints on the respective model is implemented.

18. The system of claim 17, wherein the processor is further configured to select the plurality of features as a subset of features in a universe of features based on a predictive power of each respective feature in the universe of features calculated from a historical data set of event outcomes.

19. The system of claim 17, wherein the trained plurality of predictive risk models comprises a first model for users of the software application having an external risk score and a second model for users of the software application lacking the external risk score.

20. The system of claim 17, wherein the processor is further configured to generate, based on a difference between a likelihood of positive events and a likelihood of negative events, a user segmentation model including a plurality of segments, wherein:
a variation of negative event rates across the plurality of segments is maintained, and
the user segmentation model maximizes a slope of specified events across each segment of the plurality of segments.
